(19) United States
(12) Patent Application Publication
(10) Pub. No.: US 2024/0378783 A1
(43) Pub. Date: Nov. 14, 2024

(54) IMAGE PROCESSING DEVICE, LEARNING DEVICE, IMAGE PROCESSING METHOD, LEARNING METHOD, IMAGE PROCESSING PROGRAM, AND LEARNING PROGRAM

(71) Applicant: NIPPON TELEGRAPH AND TELEPHONE CORPORATION, Tokyo (JP)

(72) Inventors: Hirokazu KAMEOKA, Tokyo (JP); Takuhiro KANEKO, Tokyo (JP)

(73) Assignee: NIPPON TELEGRAPH AND TELEPHONE CORPORATION, Tokyo (JP)

(21) Appl. No.: 18/689,051

(22) PCT Filed: Sep. 6, 2021
(86) PCT No.: PCT/JP2021/032727

§ 371 Date: Mar. 4, 2024

(51) Int. Cl. G06T 13/20; G06T 13/40; G10L 15/06; G10L 15/16

(52) U.S. Cl. CPC G06T 13/205; G06T 13/40; G10L 15/063; G10L 15/16

(57) ABSTRACT

Provided is an image processing device 10 including: an action unit acquisition unit 101 configured to input a voice signal to a first neural network to obtain an action unit representing movement of a mimic muscle corresponding to the voice signal from the first neural network; and a face image generation unit 102 configured to input the action unit and a face still image to a second neural network to obtain a sequence of a generated image obtained by transforming an expression of the face still image into an expression corresponding to the voice signal from the second neural network.

### TECHNICAL FIELD

The technology disclosed herein relates to an image processing device, a learning device, an image processing method, a learning method, an image processing program, and a learning program.

### BACKGROUND ART

There is a disclosed technology of synthesizing a peripheral area of a lip in a face moving image on the basis of a given voice and the face moving image as if the utterance content of the voice is actually being spoken (e.g., refer to Non Patent Literature 1). In Non Patent Literature 1 and the like, an approach is adopted in which an area near a lip in a face moving image is artificially masked using a pair of a voice and a face moving image as learning data, and then a neural network for restoring a masked area only from a remaining area and a voice signal is learned. Then, after the learning is completed, a lip moving image matching the utterance content of a voice can be synthesized by restoring a moving image of the masked area by the same procedure when an arbitrary pair of the voice and a face moving image is given, and transferring the restored moving image to the area.

### CITATION LIST

### Non Patent Literature

Non Patent Literature 1: K R Prajwal, Rudrabha Mukhopadhyay, Vinay Namboodiri, and C V Jawahar, “A Lip Sync Expert Is All You Need for Speech to Lip Generation In the Wild,” Proceedings of the 28th ACM International Conference on Multimedia, pp. 484-492, 2020.

### SUMMARY OF INVENTION

### Technical Problem

In the technology disclosed in Non Patent Literature 1, although it is possible to synthesize a peripheral area of a lip in the face moving image, it is impossible to control the face expression including the movement of the lip. In a case where the above-described approach is applied with the entire face area as the masking region, it becomes difficult to hold the identity of the person. Moreover, there is no guarantee that a face moving image with an expression that suits the expression of the voice can be generated by the above-described approach.

The disclosed technology has been made in view of the above points, and an object thereof is to provide an image processing device, a learning device, an image processing method, a learning method, an image processing program, and a learning program capable of controlling a face expression including a lip in a face moving image on the basis of a given voice and the face moving image as if the utterance content of the voice is actually being spoken.

### Solution to Problem

A first aspect of the present disclosure is an image processing device including: an action unit acquisition unit configured to input a voice signal to a first neural network to obtain an action unit representing movement of a mimic muscle corresponding to the voice signal from the first neural network; and a face image generation unit configured to input the action unit and a face still image to a second neural network to obtain a sequence of a generated image obtained by transforming an expression of the face still image into an expression corresponding to the voice signal from the second neural network.

A second aspect of the present disclosure is a learning device including: a first learning unit configured to learn a first neural network that inputs a voice signal and outputs an action unit representing movement of a mimic muscle corresponding to the voice signal in a manner such that an error between the action unit outputted from a voice of a face moving image with voice and an action unit extracted in advance in each frame of the face moving image is reduced; and a second learning unit configured to learn a second neural network that inputs the action unit and a face still image and outputs a sequence of a generated image obtained by transforming an expression of the face still image into an expression corresponding to the voice signal by using a third neural network that inputs a face still image and outputs the action unit in a manner such that an error between the action unit of an input of the second neural network and an action unit outputted by inputting the generated image to the third neural network is reduced.

A third aspect of the present disclosure is an image processing method in which a computer executes processing including: inputting a voice signal to a first neural network to obtain an action unit representing movement of a mimic muscle corresponding to the voice signal from the first neural network; and inputting the action unit and a face still image to a second neural network to obtain a sequence of a generated image obtained by transforming an expression of the face still image into an expression corresponding to the voice signal from the second neural network.

A fourth aspect of the present disclosure is a learning method in which a computer executes processing including: learning a first neural network that inputs a voice signal and outputs an action unit representing movement of a mimic muscle corresponding to the voice signal in a manner such that an error between the action unit outputted from a voice of a face moving image with voice and an action unit extracted in advance in each frame of the face moving image is reduced; and learning a second neural network that inputs the action unit and a face still image and outputs a sequence of a generated image obtained by transforming an expression of the face still image into an expression corresponding to the voice signal by using a third neural network that inputs a face still image and outputs the action unit in a manner such that an error between the action unit of an input of the second neural network and an action unit outputted by inputting the generated image to the third neural network is reduced.

A fifth aspect of the present disclosure is an image processing program capable of causing a computer to function as the image processing device according to the first aspect.

A sixth aspect of the present disclosure is a learning program capable of causing a computer to function as the learning device according to the second aspect.

### Advantageous Effects of Invention

According to the disclosed technology, it is possible to provide a learning device, an image processing device, a learning method, an image processing method, a learning program, and an image processing program capable of controlling a face expression including a lip in a face moving image on the basis of a given voice and the face moving image as if the utterance content of the voice is actually being spoken.

### BRIEF DESCRIPTION OF DRAWINGS

FIG. 1 is a diagram illustrating an outline of the present embodiment.

FIG. 2 is a block diagram illustrating a hardware configuration of an image processing device.

FIG. 3 is a block diagram illustrating an example of a functional configuration of the image processing device.

FIG. 4 is a block diagram illustrating a hardware configuration of a learning device.

FIG. 5 is a block diagram illustrating an example of a functional configuration of the learning device.

FIG. 6 is a diagram illustrating an example of learning of a first neural network.

FIG. 7 is a diagram illustrating an example of learning of a second neural network.

FIG. 8 is a flowchart illustrating a flow of image processing by an image processing device.

FIG. 9A is a diagram illustrating an effect of the image processing device.

FIG. 9B is a diagram illustrating an effect of the image processing device.

### DESCRIPTION OF EMBODIMENTS

Hereinafter, an example of an embodiment of the disclosed technology will be described with reference to the drawings. Note that same or equivalent components and parts are denoted by the same reference numerals in the drawings. Moreover, dimensional ratios in the drawings are exaggerated for convenience of description and thus may be different from actual ratios.

### DESCRIPTION OF RELATED ART

First, an outline of the disclosed technology will be described. The disclosed technology deals with a problem of using a voice signal and a face still image as inputs and controlling an expression of the face still image in accordance with an expression of a voice. Technology related to the problem will be described below.

As described above, Non Patent Literature 1 and the like disclose a technology of synthesizing a peripheral area of a lip in a face moving image on the basis of a given voice and the face moving image as if the utterance content of the voice is actually being spoken. However, in the technology disclosed in Non Patent Literature 1, although it is possible to synthesize the peripheral area of the lip in the face moving image, it is impossible to control the face expression including the movement of the lip. In a case where the above-described approach is applied with the entire face area as the masking region, it becomes difficult to hold the identity of the person. Moreover, there is no guarantee that a face moving image with an expression that suits the expression of the voice can be generated by the above-described approach.

Examples of technology related to the disclosed technology other than lip moving image generation include a voice expression recognition technology, a face expression recognition technology, and an image style transformation technology.

The voice expression recognition and the face expression recognition are respectively a technique of estimating a discrete class (emotion class) expressing the emotion state of the speaker by using the voice as an input and a technology of estimating the emotion class of the person by using the face image as an input, and many studies have been conducted so far on both technologies. It can be said that the difficulty of expression recognition lies in that the definition of an emotion class is subjective and non-unique regardless of whether the input is a voice or a face image. However, in recent years, many technologies capable of achieving prediction close to a labeling result by a human have been proposed for face expression recognition.

On the other hand, for voice expression recognition, the performance of existing technology is still limited, and many problems remain at present. Reference Literature 1 focuses on the fact that the existing face expression recognition technology has high accuracy to some extent, and proposes an idea of learning a voice expression recognizer so as to coincide with the prediction result of a face expression recognizer as much as possible in each frame by using a large amount of face moving images with voice and the learned appropriate face expression recognizer under the assumption that the emotion of a person who is uttering appears in some form in both the face and the voice. The authors call this approach “Crossmodal Transfer”.
(Reference Literature 1) Samuel Albanie, Arsha Nagrani, Andrea Vedaldi, and Andrew Zisserman, “Emotion Recognition in Speech using Cross-Modal Transfer in the Wild”, Proceedings of the 26th ACM international conference on Multimedia, pp. 292-301, 2018.

Image style transformation technology is a task aimed at transforming a given image into a desired style, and research on the technology has been rapidly developed in recent years with progress in study on various deep generation models. The expression transformation of a face image can be regarded as a type of image style transformation in which the image is specialized in the face image and the style is specialized in the expression. For example, Reference Literature 2 proposes an image style transformation method called “StarGAN” to which generative adversarial networks (GAN) are applied, and illustrates an example in which StarGAN is applied to transformation of a style (hair color, sex, age, or facial expression) of a face image.
(Reference Literature 2) Yunjey Choi, Minje Choi, Munyoung Kim, Jung-Woo Ha, Sunghun Kim, and Jaegul Choo, “Star-GAN: Unified Generative Adversarial Networks for Multi-Domain Image-to-Image Translation”, Proceedings of the IEEE Conference on Computer Vision and Pattern Recognition (CVPR), pp. 8789-8797, 2018.

In StarGAN, since information regarding the style to be obtained by transformation is specified in a discrete class, only transformation into an expression of a representative emotion class such as anger, joy, fear, surprise, or sadness can be performed. On the other hand, Reference Literature 3 proposes an idea of substituting this with a continuous value representing movement of a mimic muscle called an action unit, and enables transformation into various expressions including subtle expressions. Moreover, Reference Literature 3 also proposes an original network architecture specialized for the purpose of face expression transformation, and the authors call this system “GANimation”.
(Reference Literature 3) Albert Pumarola, Antonio Agudo, Aleix M. Martinez, Alberto Sanfeliu, and Francesc Moreno-Noguer, “GANimation: Anatomically-aware Facial Animation from a Single Image”, Proceedings of the European Conference on Computer Vision (ECCV), pp. 818-833, 2018.

Although all of the conventional technologies described above are related to the disclosed technology, the face expression control by voice, which is the object of the disclosed technology, cannot be realized by each technology alone. On the other hand, the disclosed technology makes it possible to control the face expression including a lip in a face moving image on the basis of a given voice and the face moving image as if the utterance content of the voice is actually being spoken.

### <Overall Outline>

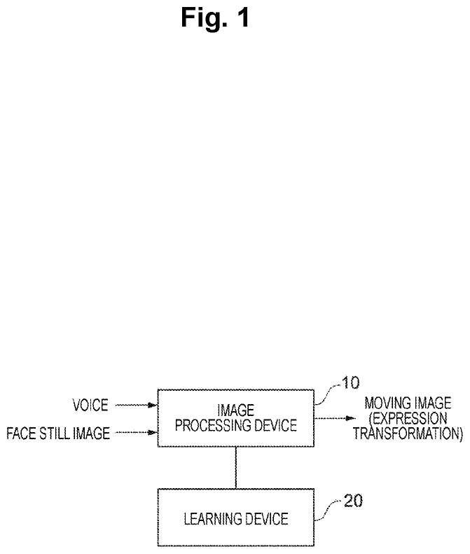

FIG. 1 is a diagram illustrating an outline of the present embodiment.

An image processing device 10 is a device that, when voice data and a face still image that is a still image including an imaged face are inputted, transforms an expression of the face still image in association with the voice data and outputs a moving image. Specifically, the image processing device 10 predicts an action unit sequence from voice data, and generates and outputs a moving image by using a face still image and the predicted action unit sequence. An action unit sequence is a continuous value representing the movement of a mimic muscle. The image processing device 10 uses a first neural network when predicting an action unit sequence from voice data, and uses a second neural network when generating a moving image using a face still image and the predicted action unit sequence.

A learning device 20 is a device that learns the first neural network and the second neural network used by the image processing device 10. Note that, although the image processing device 10 and the learning device 20 are drawn as separate devices in FIG. 1, the present disclosure is not limited to such an example. The image processing device 10 and the learning device 20 may be the same device.

### (Image Processing Device)

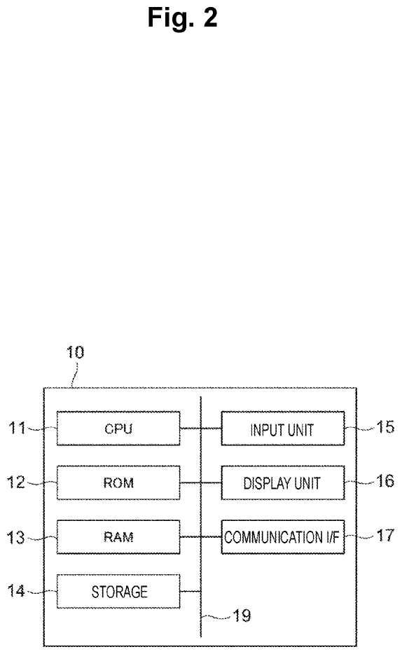

FIG. 2 is a block diagram illustrating a hardware configuration of the image processing device 10.

As illustrated in FIG. 2, the image processing device 10 includes a central processing unit (CPU) 11, a read only memory (ROM) 12, a random access memory (RAM) 13, a storage 14, an input unit 15, a display unit 16, and a communication interface (I/F) 17. The components are communicably connected with each other via a bus 19.

The CPU 11 is a central processing unit, which executes various programs and controls each unit. That is, the CPU 11 reads a program from the ROM 12 or the storage 14, and executes the program using the RAM 13 as a working area. The CPU 11 performs control of each of the components described above and various types of calculation processing according to a program stored in the ROM 12 or the storage 14. In the present embodiment, the ROM 12 or the storage 14 stores an image processing program for transforming an expression of a face still image in association with voice data and outputting a moving image.

The ROM 12 stores various programs and various types of data. The RAM 13 serving as a working area temporarily stores programs or data. The storage 14 is configured with a storage device such as a hard disk drive (HDD) or a solid state drive (SSD), and stores various programs including an operating system and various types of data.

The input unit 15 includes a pointing device such as a mouse and a keyboard, and is used to perform various inputs.

The display unit 16 is, for example, a liquid crystal display, and displays various types of information. The display unit 16 may function as the input unit 15 by adopting a touch panel system.

The communication interface 17 is an interface for communicating with other equipment. For the communication, for example, a wired communication standard such as Ethernet (registered trademark) or FDDI, or a wireless communication standard such as 4G, 5G, or Wi-Fi (registered trademark) is used.

Next, a functional configuration of the image processing device 10 will be described.

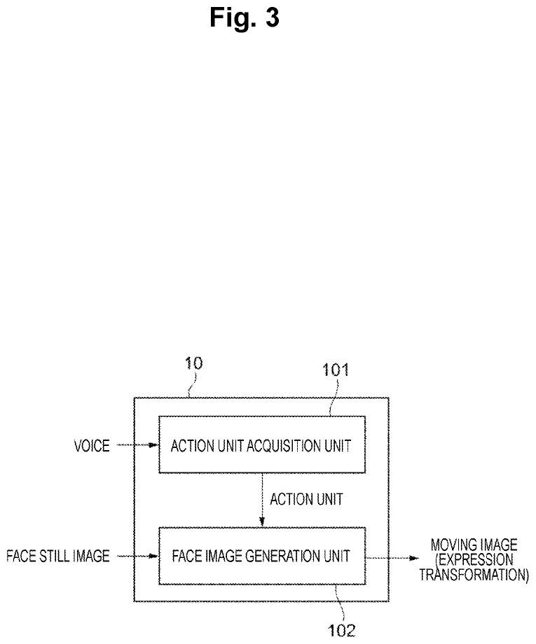

FIG. 3 is a block diagram illustrating an example of a functional configuration of the image processing device 10.

As illustrated in FIG. 3, the image processing device 10 includes an action unit acquisition unit 101 and a face image generation unit 102 as functional configurations. Each functional configuration is implemented by the CPU 11 reading an image processing program stored in the ROM 12 or the storage 14, developing the image processing program in the RAM 13, and executing the image processing program.

### (Action Unit Acquisition Unit)

The action unit acquisition unit 101 inputs voice data to the first neural network, and predicts and acquires an action unit sequence. The first neural network is learned using a large amount of face moving images with voice. Specific learning processing of the first neural network will be described later.

### (Face Image Generation Unit)

The face image generation unit 102 inputs the face still image and the action unit sequence acquired by the action unit acquisition unit 101 to the second neural network. The second neural network outputs a sequence of a generated image that is a sequence of a face still image obtained by transforming facial expression into voice corresponding to the action unit sequence. The sequence of a generated image outputted from the second neural network forms a moving image. The second neural network extracts an action unit from a large amount of face images in advance, and is learned using a learning method adopted in an existing image style transformation technology such as GANimation. Specific learning processing of the second neural network will be described later.

With such a configuration, the image processing device 10 according to the present embodiment can generate a face moving image in which the expression of the face still image is temporally changed so as to match the action unit sequence predicted from the voice data.

### (Learning Device)

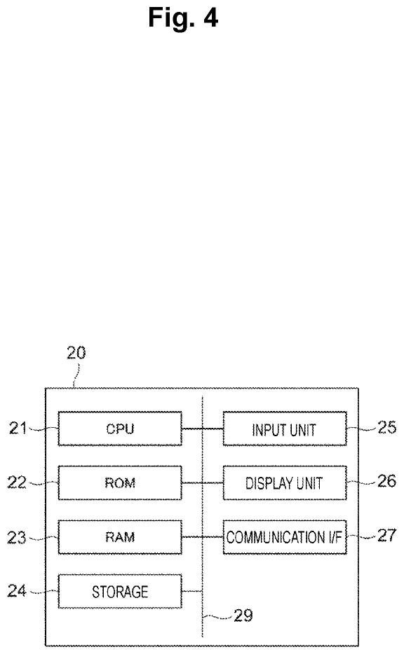

FIG. 4 is a block diagram illustrating a hardware configuration of the learning device 20.

As illustrated in FIG. 4, the learning device 20 includes a CPU 21, a ROM 22, a RAM 23, a storage 24, an input unit 25, a display unit 26, and a communication interface (I/F) 27. The components are communicably connected with each other via a bus 29.

The CPU 21 is a central processing unit, which executes various programs and controls each unit. That is, the CPU 21 reads a program from the ROM 22 or the storage 24, and executes the program using the RAM 23 as a working area. The CPU 21 performs control of each of the components described above and various types of calculation processing according to a program stored in the ROM 22 or the storage 24. In the present embodiment, the ROM 22 or the storage 24 stores a learning program of learning the first neural network and the second neural network for transforming the expression of a face still image in association with voice data and outputting a moving image.

The ROM 22 stores various programs and various types of data. The RAM 23 as a working area temporarily stores programs or data. The storage 24 is configured with a storage device such as an HDD or an SSD, and stores various programs including an operating system and various types of data.

The input unit 25 includes a pointing device such as a mouse and a keyboard, and is used to perform various inputs.

The display unit 26 is, for example, a liquid crystal display, and displays various types of information. The display unit 26 may function as the input unit 25 by adopting a touch panel system.

The communication interface 27 is an interface for communicating with other equipment. For the communication, for example, a wired communication standard such as Ethernet (registered trademark) or FDDI, or a wireless communication standard such as 4G, 5G, or Wi-Fi (registered trademark) is used.

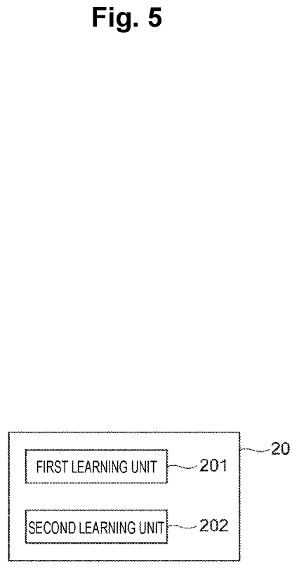

Next, a functional configuration of the learning device 20 will be described. FIG. 5 is a block diagram illustrating an example of a functional configuration of the learning device 20.

As illustrated in FIG. 5, the learning device 20 includes a first learning unit 201 and a second learning unit 202 as functional configurations. Each functional configuration is realized by the CPU 21 reading an image processing program stored in the ROM 22 or the storage 24, developing the image processing program in the RAM 23, and executing the image processing program.

The first learning unit 201 learns the first neural network used by the action unit acquisition unit 101. Specifically, the first learning unit 201 learns the first neural network in a manner such that an error between the action unit outputted from the voice of the face moving image with voice and an action unit extracted in advance in each frame of the face moving image is reduced.

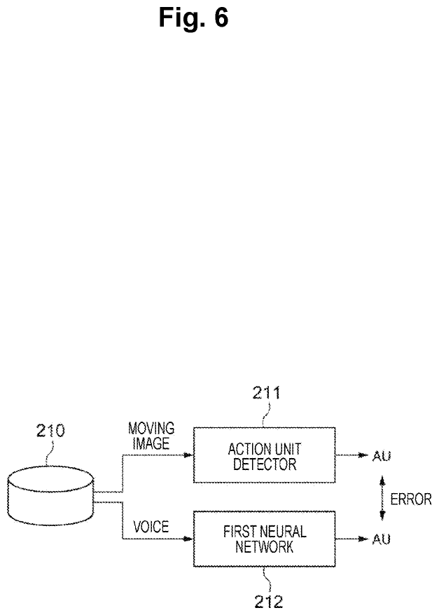

An example of learning of the first neural network by the first learning unit 201 will be described. FIG. 6 is a diagram for explaining an example of learning of the first neural network by the first learning unit 201.

The first learning unit 201 uses the data of the face moving image with voice stored in data set 210 when learning the first neural network. As the data set 210, for example, VoxCeleb2 or the like can be used. The first learning unit 201 detects an action unit corresponding to the moving image from the data of the face moving image with voice stored in the data set 210 by an action unit detector 211. Moreover, the first learning unit 201 extracts only voice from the data of the face moving image with voice stored in the data set 210, inputs the voice to a first neural network 212, and outputs an action unit from the first neural network 212. There may be an error between the action unit outputted from the action unit detector 211 and the action unit outputted from the first neural network 212. The first learning unit 201 learns the first neural network 212 in a manner such that these action units coincide with each other.

A character with “⁻” added above a symbol (e.g., X) in the following mathematical formulas may be expressed as ⁻X or the like below. Moreover, a character with “\hat{ }” added above a symbol (e.g., X) in the mathematical formulas may be expressed as \hat{ }X below.

An action unit sequence extracted in advance from a face moving image part of the face moving image with voice will be denoted by y₁, . . . , y_{N}, and a signal waveform or acoustic feature amount vector sequence of the voice part will be denoted by s₁, . . . , S_{M}. Although the respective sequence lengths are set to N and M since the frame rates of the moving image and the voice may be different from each other, N=M is satisfied in a case where the frame rates are the same. However, sₘ (m is an integer between 1 and M) is a waveform obtained by frame division in the case of a signal waveform (when the frame length is 1, sₘ denotes a scalar, and M denotes the total number of samples of the voice signal), and is a vector of an appropriate dimension having each feature amount as an element in the case of an acoustic feature amount vector. The action unit acquisition unit 101 uses the first neural network 212 that predicts Y=[y₁, . . . , y_{N}] from S=[s₁, . . . , S_{M}]. When representing the first neural network 212 as f_{θ}(·), the following expression is satisfied.

$${}^{\hat{}} Y = {f}_{θ} ( S )$$

A goal of learning of the first learning unit 201 is to determine the model parameter θ using all training samples in a manner such that the following expression is satisfied.

$$Y ≃ \hat{Y} \qquad [ Math . 1 ]$$

The f_{θ}(·) is represented by a convolutional neural network (CNN), a recurrent neural network (RNN), or the like. In a case where a CNN is used, \hat{ }Y is adjusted to have the same size as Y by appropriately using a convolution layer, an up-sampling layer, and a down-sampling layer having a stride width of 1. In a case where an RNN is used, the frame rates of S and Y are matched in advance so that N=M is satisfied. As a criterion for the error between \hat{ }Y and Y, any criterion may be used as long as it has a scale that becomes 0 only when both completely coincide with each other and increases as the absolute value of the error increases, and, for example, the norm of an error matrix Y−\hat{ }Y can be used.

The second learning unit 202 learns the second neural network used by the face image generation unit 102. Specifically, the second learning unit 202 learns the second neural network using a third neural network that inputs a face still image and outputs an action unit in a manner such that an error between an action unit of an input of the second neural network and an action unit outputted by inputting a generated image outputted from the second neural network to the third neural network is reduced.

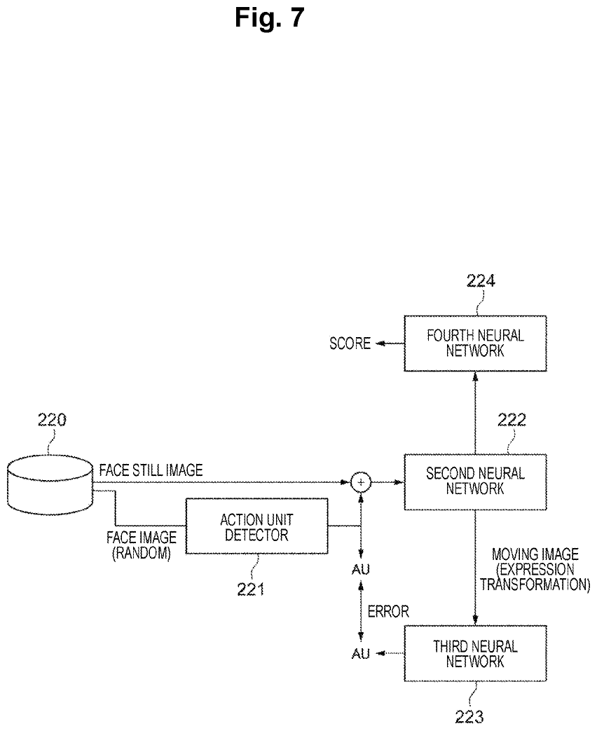

An example of learning of the second neural network by the second learning unit 202 will be described. FIG. 7 is a diagram for explaining an example of learning of the second neural network by the second learning unit 202. Although the face image generation unit 102 uses a model of above-described GANimation in the present embodiment, the model used by the face image generation unit 102 is not limited to GANimation. The second learning unit 202 uses data of a face image stored in the data set 220 when learning the second neural network. As the data set 220, for example, CelebA or the like can be used.

The input face image F is represented as the following expression.

$$F ∈ {ℝ}^{C \times H \times W} \qquad [ Math . 2 ]$$

H and W respectively denote the vertical size and the horizontal size of the image, and C denotes the number of channels (C=3 is satisfied in the case of an RGB image). Moreover, a vector generated by random sampling or an action unit extracted from an appropriate face image other than the above face image is represented as the following expression.

$$y ∈ {ℝ}^{D} \qquad [ Math . 3 ]$$

D denotes the number of dimensions of the action unit.

The face image generation unit 102 uses a second neural network 222 represented by \hat{ }F=g_{ϕ}(F, y). That is, \hat{ }F is a face image generated by the second neural network 222, and is hereinafter also referred to as a “generated face image”. Then, the second learning unit 202 determines the parameter ϕ of the second neural network 222 according to the following criterion as a goal of learning.

The second neural network 222 may be a CNN that directly generates the generated face image \hat{ }F, but in GANimation, an attention mask and a color mask are generated as internal representation, and an image in which an expression has been transformed is generated from an input image, the attention mask, and the color mask. The attention mask represents how much each pixel of an original image contributes to a final rendered image. The color mask holds color information of the transformed image over the entire image. The attention mask A is represented as the following expression.

$$A ∈ {( 0 , 1 )}^{1 \times H \times W} \qquad [ Math . 4 ]$$

Moreover, the color mask C is represented as the following expression.

$$C ∈ {ℝ}^{C \times H \times W} \qquad [ Math . 5 ]$$

\hat{ }F is represented as the following formula from the attention mask A and the color mask C.

$$\hat{F} = ( 1 - A ) ⊙ C + A ⊙ F \qquad [ Math . 6 ]$$

The 1 in the above formula represents an array in which all elements are 1, and

⊙ [Math. 7]

represents an operation of calculating a product for each element. When arrays of arguments have different sizes, one array is duplicated in the channel direction, the sizes of both arrays are matched, and the product for each element is obtained. The attention mask is an amount indicating which area in the input image is to be transformed, and the color mask is an amount corresponding to the difference image between the transformed image and the input image.

In the present embodiment, an adversarial loss is introduced for the purpose of making the generated face image \hat{ }F look like a real face image. Regarding the adversarial loss, a fourth neural network 224 that outputs a score to the input image is considered. The fourth neural network 224 is represented as d_{ψ}(·). The d_{ψ}(·) is a neural network that becomes relatively low if the input is outputted from the second neural network 222, and becomes relatively high with an actual image. The second learning unit 202 performs learning in a manner such that this loss increases with respect to ψ, and this loss decreases with respect to ϕ. By learning in this manner, g_{ϕ}(·) can be learned in a manner such that the generated face image \hat{ }F from g_{ϕ}(·) looks like a real face image. Moreover, the loss may include a penalty term such that d_{ψ}(·) becomes Lipschitz-continuous for the purpose of stabilizing the learning. To be Lipschitz-continuous means to suppress the absolute value of the gradient to 1 for any input.

When the above-described architecture is used, \hat{ }F=F is satisfied in a case where all elements of the attention mask A are 1, and the generated face image is the actual image of the input. Accordingly, in a case where only the adversarial loss is used as a criterion, it is expected that learning proceeds in a manner such that all elements of the attention mask A are always 1. To avoid this situation, it is necessary to guide learning in a manner such that as many elements of the attention mask A as possible become 0. That is, it is necessary to guide learning in a manner such that g_{ϕ}(·) transforms only an area as small as possible in the input image.

Therefore, for example, the norm of the attention mask A may be included in the learning loss as a regularization term. Moreover, in order to make the generated face image \hat{ }F smooth, it is desirable that the attention mask is smooth. In order to make the attention mask as smooth as possible, for example, a loss that takes a smaller value when each element of the attention mask A has a value closer to an element of adjacent coordinates may be considered. The sum of these two losses is referred to as an attention loss in the present embodiment.

It is desirable that the generated face image \hat{ }F is a face image of an expression corresponding to the action unit y of the input. This can be checked on the basis of whether the action unit extracted from the generated face image \hat{ }F is equal to the action unit y of the input or not. A third neural network 223 has such a check function. The third neural network is represented as r_{ρ}(·). The second learning unit 202 includes a criterion for measuring an error between r_{ρ}(\hat{ }F) and the action unit y of the input in the learning loss. Moreover, it is desirable that an output obtained by inputting the actual image F to the third neural network 223 coincides with the action unit y′ previously extracted from the actual image by an action unit detector 221. Thus, a criterion for measuring an error between r_{ρ}(F) and the action unit y′ is included in the learning loss. The sum of these losses is referred to as an AU prediction loss in the present embodiment.

Although both r_{ρ}(·) and d_{ψ}(·) are neural networks of arbitrary architecture having a face image as an input, these can be expressed as two independent neural networks or may be a single multi-task neural network. A single multi-task neural network means a neural network having a structure in which a common network is shared from an input layer to a middle layer, and a network is divided into two branches from the middle layer to a final layer.

It is desirable that an image g_{ϕ}(\hat{ }F, y′)=g_{ϕ}(g_{ϕ}(F, v), y′) obtained by transforming the generated face image \hat{ }F again on the basis of the action unit y′ of the input image F using g_{ϕ}(·) coincides with the original input image F. In order to cause g_{ϕ}(·) to learn such behavior, the second learning unit 202 includes a criterion for measuring the magnitude of the error between g_{ϕ}(g_{ϕ}(F, y), y′) and the input image F in the learning loss. In the present embodiment, such a loss is referred to as a cyclic consistent loss.

The second learning unit 202 learns the parameters ϕ, ψ, and ρ of each neural network on the basis of the weighted sum of losses described above.

Next, the operation of the image processing device 10 will be described.

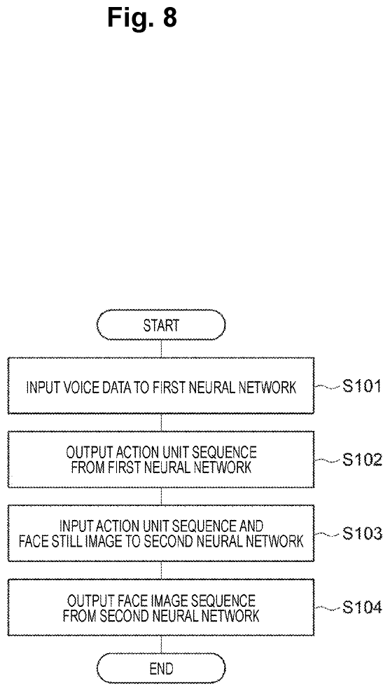

FIG. 8 is a flowchart illustrating a flow of image processing by the image processing device 10. Image processing is performed by the CPU 11 reading an image processing program from the ROM 12 or the storage 14, developing the image processing program in the RAM 13, and executing the image processing program.

In step S101, the CPU 11 as the action unit acquisition unit 101 inputs voice data to the first neural network.

When the voice data is inputted to the first neural network in step S101, the CPU 11 as the action unit acquisition unit 101 then outputs the action unit sequence obtained from the voice data from the first neural network in step S102.

When the action unit sequence is outputted from the first neural network in step S102, the CPU 11 as the face image generation unit 102 then inputs the action unit sequence outputted from the first neural network and the face still image, the expression of which is desired to be transformed, to the second neural network in step S103.

When the action unit sequence and the face still image are inputted to the second neural network in step S103, the CPU 11 as the face image generation unit 102 then outputs the face image sequence obtained from the action unit sequence and the face still image from the second neural network in step S104.

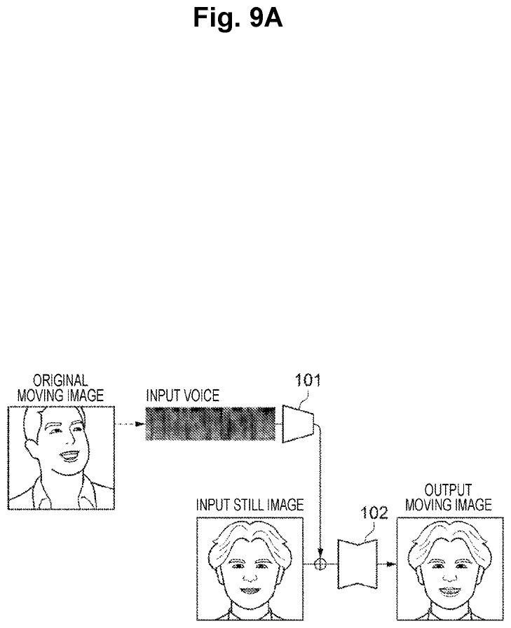

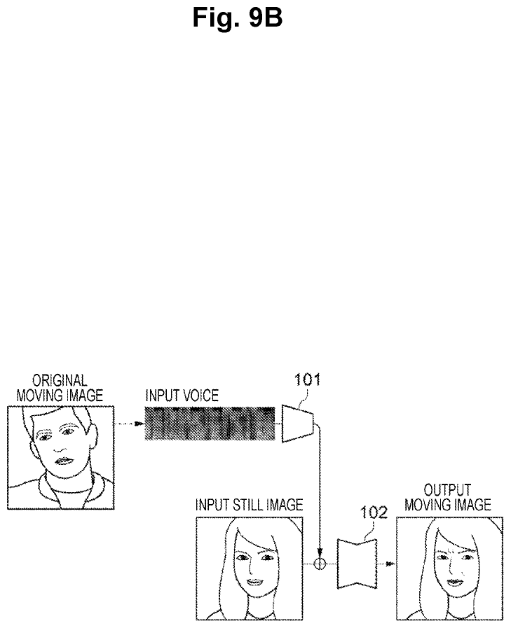

FIGS. 9A and 9B are diagrams illustrating effects provided by the image processing device 10. With the image processing device 10 according to the present embodiment, as illustrated in FIGS. 9A and 9B, the expression of an utterer of an input voice is appropriately transferred to an inputted still image, and a natural face image can be generated without impairing the identity of the original person.

Note that the image processing or the learning processing executed by the CPU reading software (program) in each of the above embodiments may be executed by various processors other than the CPU. Examples of the processors in this case include a programmable logic device (PLD), a circuit configuration of which can be changed after manufacturing, such as a field-programmable gate array (FPGA), and a dedicated electric circuit that is a processor having a circuit configuration exclusively designed for executing a specific process, such as an application specific integrated circuit (ASIC). Moreover, the image processing or the learning processing may be executed by one of these various processors, or may be executed by a combination of two or more processors of the same type or different types (for example, a plurality of FPGAs, a combination of a CPU and an FPGA, and the like). More specifically, a hardware structure of the various processors is an electric circuit in which circuit elements such as semiconductor elements are combined.

Moreover, although an aspect in which an image processing or learning processing program is stored (installed) in advance in the storage 14 or the storage 24 has been described in each of the above embodiments, the present invention is not limited thereto. The program may be provided in the form of a program stored in a non-transitory storage medium such as a compact disk read only memory (CD-ROM), a digital versatile disk read only memory (DVD-ROM), or a universal serial bus (USB) memory. Moreover, the program may be downloaded from an external device via a network.

Regarding the above embodiment, the following supplementary notes are further disclosed.
(Supplement 1)

An image processing device including:
a memory; and
at least one processor connected with the memory,
wherein the processor is configured to:
input a voice signal to a first neural network to obtain an action unit representing movement of a mimic muscle corresponding to the voice signal from the first neural network; and
input the action unit and a face still image to a second neural network to obtain a sequence of a generated image obtained by transforming an expression of the face still image into an expression corresponding to the voice signal from the second neural network.
(Supplement 2)

A non-transitory storage medium storing a program executable by a computer to execute image processing including:
inputting a voice signal to a first neural network to obtain an action unit representing movement of a mimic muscle corresponding to the voice signal from the first neural network; and
inputting the action unit and a face still image to a second neural network to obtain a sequence of a generated image obtained by transforming an expression of the face still image into an expression corresponding to the voice signal from the second neural network.
(Supplement 3)

A learning device including:
a memory; and
at least one processor connected with the memory,
wherein the processor is configured to:
learn a first neural network that inputs a voice signal and outputs an action unit representing movement of a mimic muscle corresponding to the voice signal in a manner such that an error between the action unit outputted from a voice of a face moving image with voice and an action unit extracted in advance in each frame of the face moving image is reduced; and
learn a second neural network that inputs the action unit and a face still image and outputs a sequence of a generated image obtained by transforming an expression of the face still image into an expression corresponding to the voice signal,
by using a third neural network that inputs a face still image and outputs the action unit,
in a manner such that an error between the action unit of an input of the second neural network and an action unit outputted by inputting the generated image to the third neural network is reduced.
(Supplement 4)

A non-transitory storage medium storing a program executable by a computer to execute learning processing including:
learning a first neural network that inputs a voice signal and outputs an action unit representing movement of a mimic muscle corresponding to the voice signal in a manner such that an error between the action unit outputted from a voice of a face moving image with voice and an action unit extracted in advance in each frame of the face moving image is reduced; and
learning a second neural network that inputs the action unit and a face still image and outputs a sequence of a generated image obtained by transforming an expression of the face still image into an expression corresponding to the voice signal,
by using a third neural network that inputs a face still image and outputs the action unit,
in a manner such that an error between the action unit of an input of the second neural network and an action unit outputted by inputting the generated image to the third neural network is reduced.

### REFERENCE SIGNS LIST

10 Image processing device
20) Learning device
101 Action unit acquisition unit
102 Face image generation unit

1. An image processing device comprising:
a memory; and
at least one processor connected to the memory,
wherein the processor is configured to
input a voice signal to a first neural network to obtain an action unit representing movement of a mimic muscle corresponding to the voice signal from the first neural network; and
input the action unit and a face still image to a second neural network to obtain a sequence of a generated image obtained by transforming an expression of the face still image into an expression corresponding to the voice signal from the second neural network.

2. The image processing device according to claim 1, wherein
the processor is further configured to:
learn the first neural network in a manner such that an error between an action unit outputted from a voice signal of a face moving image with voice and an action unit extracted in advance in each frame of the face moving image is reduced; and
learn the second neural network by using a third neural network that inputs a face still image and outputs an action unit in a manner such that an error between the action unit of an input of the second neural network and an action unit outputted by inputting the generated image to the third neural network is reduced.

3. A learning device comprising:
a memory; and
at least one processor connected to the memory,
wherein the processor is configured to
learn a first neural network that inputs a voice signal and outputs an action unit representing movement of a mimic muscle corresponding to the voice signal in a manner such that an error between the action unit outputted from a voice of a face moving image with voice and an action unit extracted in advance in each frame of the face moving image is reduced; and
learn a second neural network that inputs the action unit and a face still image and outputs a sequence of a generated image obtained by transforming an expression of the face still image into an expression corresponding to the voice signal,
by using a third neural network that inputs a face still image and outputs the action unit,
in a manner such that an error between the action unit of an input of the second neural network and an action unit outputted by inputting the generated image to the third neural network is reduced.

4. The learning device according to claim 3, wherein the processor is configured to learns the third neural network in a manner such that an error between an action unit generated by the third neural network from a still image of learning data and an action unit extracted from a still image of the learning data is reduced.

5. An image processing method in which a computer executes processing comprising:
inputting a voice signal to a first neural network to obtain an action unit representing movement of a mimic muscle corresponding to the voice signal from the first neural network; and
inputting the action unit and a face still image to a second neural network to obtain a sequence of a generated image obtained by transforming an expression of the face still image into an expression corresponding to the voice signal from the second neural network.

6-8. (canceled)
